(19) United States
(12) Patent Application Publication
(10) Pub. No.: US 2014/0295292 A1
(43) Pub. Date: Oct. 2, 2014

(54) ELECTROLYTE SOLUTION FOR LITHIUM-AIR BATTERY

(71) Applicant: Hirofumi NAKAMOTO, Susono-shi (JP)

(72) Inventor: Hirofumi NAKAMOTO, Susono-shi (JP)

(73) Assignee: TOYOTA JIDOSHA KABUSHIKI KAISHA, Toyota-shi (JP)

(21) Appl. No.: 14/220,403

(22) Filed: Mar. 20, 2014

(30) Foreign Application Priority Data
Mar. 29, 2013 (JP) 2013-071492

(51) Int. Cl. H01M 8/08; H01M 12/08

(52) U.S. Cl. CPC H01M 8/08; H01M 12/08
USPC 429/403; 429/499

(57) ABSTRACT

An electrolyte solution for a lithium-air battery contains an ionic liquid that has a cation in which ether groups are incorporated in parallel.

### INCORPORATION BY REFERENCE

The disclosure of Japanese Patent Application No. 2013-071492 filed on Mar. 29, 2013 including the specification, drawings and abstract is incorporated herein by reference in its entirety.

### BACKGROUND OF THE INVENTION

1. Field of the Invention

The invention relates to an electrolyte solution that is used in a lithium-air battery.

2. Description of Related Art

The dissemination and development of devices such as cellular telephones in recent years has been accompanied by a desire to increase the capacity of the batteries that are their power sources. Within this context, metal-air batteries have a high energy density because they can undergo charging and discharge by carrying out oxidation/reduction reactions on oxygen at an air electrode that uses atmospheric oxygen as the positive electrode active material and by carrying out oxidation/reduction reactions at the negative electrode on a metal that constitutes the negative electrode. Metal-air batteries have thus been receiving attention as high-capacity batteries that are superior to the lithium ion batteries currently in general use (National Institute of Advanced Industrial Science and Technology (AIST) “Development of a New-type Lithium-Air Battery with Large Capacity”, [online], press release of Feb. 24, 2009, [retrieved Aug. 19, 2011], Internet:

<http://www.aist.go.jp/aist_j/press_release/pr2009/pr20090224/pr20090224.html>). English page:
<http://www.aist.gojp/aist_e/latest_research/2009/20090727/20090727.html>.

Organic solvents have been used as nonaqueous electrolytes in metal-air batteries, but organic solvents are volatile and are also miscible with water and as a consequence there have been stability problems with long-term operations. During long-term battery operation, the battery resistance has undergone an increase due to the evaporation of the electrolyte solution from the positive electrode (air electrode) side, or there has been a risk of corrosion of the lithium metal that is the negative electrode due to the infiltration of moisture into the interior of the battery. These phenomena are factors that impair the long-term discharge that is a characteristic feature of air batteries.

With the goal of providing lithium-air batteries capable of long-term stable battery operation as achieved by inhibiting the decline induced by electrolyte solution volatility and suppressing the admixture of moisture into the battery interior, air batteries have been introduced that use an ionic liquid, e.g.,
N,N-diethyl-N-methyl-N-(2-methoxyethyl)ammonium bis(trifluoromethanesulfonyl)amide (DEMETFSA) as the nonaqueous electrolyte (Japanese Patent Application Publication No. 2011-003313 (JP 2011-003313 A)). Here, ionic liquid denotes a material that is a liquid at normal temperature (15° C. to 25° C.) and is composed of only an ionic molecule that combines a cation and an anion.

### SUMMARY OF THE INVENTION

While the use of an ionic liquid such as
N,N-diethyl-N-methyl-N-(2-methoxyethyl)ammonium bis(trifluoromethanesulfonyl)amide (DEMETFSA) for the electrolyte solution of an air battery does provide a certain effect with regard to inhibiting the decline induced by the volatility of the electrolyte solution and suppressing the admixture of moisture into the battery interior, it still cannot be said that a satisfactory output as a battery is exhibited by an air battery that uses a conventional ionic liquid such as DEMETFSA for its electrolyte solution. Accordingly, there is desire for an electrolyte solution that can provide further improvements in the output of lithium-air batteries.

Intensive research was carried out into electrolyte solutions that could provide additional improvements in the output of lithium-air batteries, and it was discovered as a result that an ionic liquid that has a cation that incorporates ether groups in parallel has a high LiOₓ production capacity and can contribute to improving the output of lithium-air batteries.

The invention is an electrolyte solution for use in a lithium-air battery, containing an ionic liquid that has a cation in which ether groups are incorporated in parallel.

The invention provides a lithium-air battery electrolyte solution that has an excellent LiOₓ production capacity.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram that shows the Li ion coordination geometry and the O₂ supply capacity when bis(trifluoromethanesulfonyl)amide (TFSA) is used as the anion moiety and N,N-diethyl-N-methyl-N-(2-methoxyethyl)ammonium (DEME), which has a single ether group, is used as the cation moiety;

FIG. 2 is a schematic diagram that shows the Li ion coordination geometry and the O₂ supply capacity when bis(trifluoromethanesulfonyl)amide (TFSA) is used as the anion moiety and DEME3, in which three ether groups are incorporated in series, is used as the cation moiety;

FIG. 3 is a schematic diagram that shows the Li ion coordination geometry and the O₂ supply capacity when bis(trifluoromethanesulfonyl)amide (TFSA) is used as the anion moiety and N-methyl-N,N,N-tri(2-methoxyethyl)ammonium (N1(1o2)₃), in which three ether groups are incorporated in parallel, is used as the cation moiety; and

FIG. 4 contains linear sweep voltammetric (LSV) curves measured on the electrolyte solutions.

### DETAILED DESCRIPTION OF EMBODIMENTS

Lithium-air batteries that used an electrolyte solution that contained the heretofore used ionic liquid N,N-diethyl-N-methyl-N-(2-methoxyethyl)ammonium bis(trifluoromethanesulfonyl)amide (DEMETFSA) were still unable to provide a satisfactory output as a battery.

In response to this problem, it was found that the LiOx production capacity can be improved over that heretofore available and the output characteristics of a lithium-air battery can be improved by the use in the electrolyte solution of an ionic liquid that contains a cation in which ether groups are introduced in parallel.

This ionic liquid that has a cation in which ether groups are incorporated in parallel preferably contains a quaternary ammonium cation represented by formula (1).

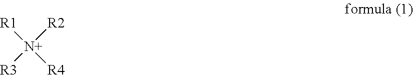

(In the formula, at least two groups among R1, R2, R3, and R4 each contain from 1 to 7 carbon atoms, a hydrogen atom, and from 1 to 3 oxygen atoms; the remaining groups each contain from 1 to 8 carbon atoms, a hydrogen atom, and from 0 to 3 oxygen atoms; and the number of oxygens present in R1, R2, R3, and R4 is a maximum of 12. The at least two groups containing the oxygen atoms among the R1, R2, R3, and R4 preferably have the same structure.)

The ionic liquid that has a cation in which ether groups are incorporated in parallel is more preferably an ionic liquid that contains an
N-ethyl-N-methyl-N,N-di(2-methoxyethyl)ammonium (N12(1o2)₂) represented by formula (2), in which two ether groups are present in parallel,

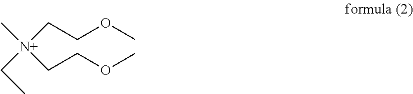

or the N-methyl-N,N,N-tri(2-methoxyethyl)ammonium (N1(1o2)₃) represented by formula (3), in which three ether groups are present in parallel,

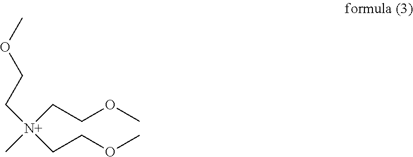

or their mixture.

The ionic liquid that has a cation in which ether groups are incorporated in parallel can contain an anion. This anion can be exemplified by
bis(trifluoromethanesulfonyl)amide (TFSA) as represented by formula (4), tetrafluoroborate, hexafluorophosphate, triflate, and so forth, wherein the use of TFSA is preferred. The ionic liquid that has a cation in which ether groups are incorporated in parallel is more preferably N12(1o2)₂TFSA, N1(1o2)₃TFSA, or their mixture.

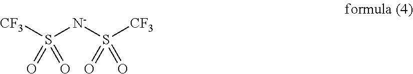 [SMILES: O=S(=O)([N-]S(=O)(=O)C(F)(F)F)C(F)(F)F]

A lithium-containing metal salt can be present in the electrolyte solution that contains an ionic liquid that has a cation in which ether groups are incorporated in parallel. A salt containing the lithium ion and an anion as exemplified by the following can be used as this lithium-containing metal salt: a halide anion such as Cl⁻, Br⁻, and I⁻; a boron-containing anion such as BF₄⁻, B(CN)₄⁻, and B(C₂O₄)₂⁻; an amide anion or imide anion such as (CN)₂N⁻, [N(CF₃)₂]⁻, and [N(SO₂CF₃)₂]⁻; a sulfate anion or sulfonate anion such as RSO₃⁻ (here and below, R denotes an aliphatic hydrocarbyl group or an aromatic hydrocarbyl group), RSO₄⁻, R^{f}SO₃⁻ (here and below, R^{f} denotes a fluorine-containing halogenated hydrocarbyl group), and R^{f}SO₄⁻; a phosphorus-containing anion such as R^{f}₂P(O)O⁻, PF₆⁻, and R^{f}₃PF₃⁻; an antimony-containing anion such as SbF₆; and an anion such as lactate, the nitrate ion, trifluoroacetate, and tris(trifluoromethanesulfonyl)methide. The lithium-containing metal salt can thus be exemplified by LiPF₆, LiBF₄, lithium bis(trifluoromethanesulfonyl)amide (LiN(CF₃SO₂)₂, referred to as LiTFSA in the following), LiCF₃SO₃, LiC₄F₉SO₃, LiC(CF₃SO₂)₃, and LiCl₄, and the use of LiTFSA is preferred. Two or more of these lithium-containing metal salts may be used in combination. The amount of addition of the lithium-containing metal salt to the ionic liquid is not particularly limited, but is preferably approximately 0.1 to 1 mol/kg.

The ether group readily coordinates with the Li ion, and it is thought that, by incorporating ether groups in parallel in the cation structure, multiple coordinations between Li ions and the cation can then be more easily realized than for the anion and the Li ion supply capacity can be raised—while maintaining a broad space that can dissolve O₂ in the ionic liquid, and as a consequence oxygen molecules and Li ions solvated by the cation can more easily react on the electrode and the LiOx production capacity can be raised.

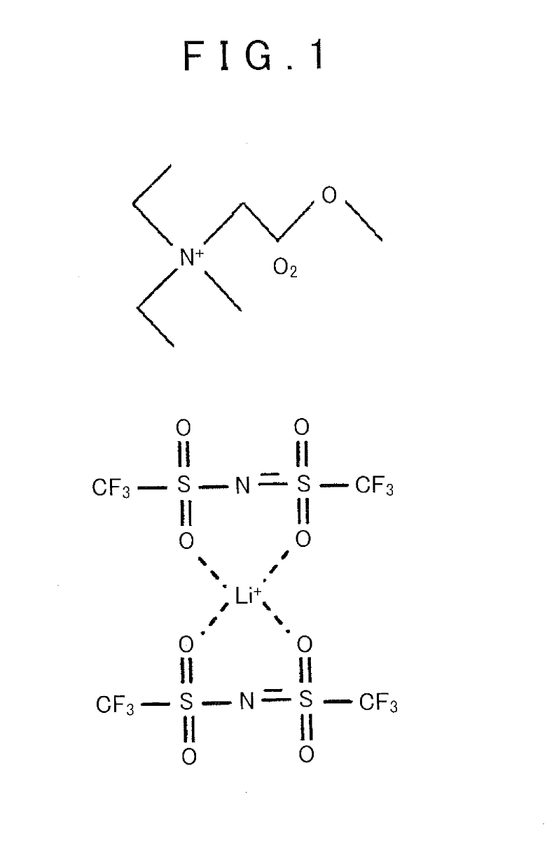

The schematic diagrams in FIGS. 1 to 3 show, as descriptive examples, the O₂ supply capacity and the Li ion coordination geometry at the ether group in the cation moiety for the use for the anion moiety of bis(trifluoromethanesulfonyl)amide (TFSA) and the use for the cation moiety of ammonium cations having different ether group-containing structures.

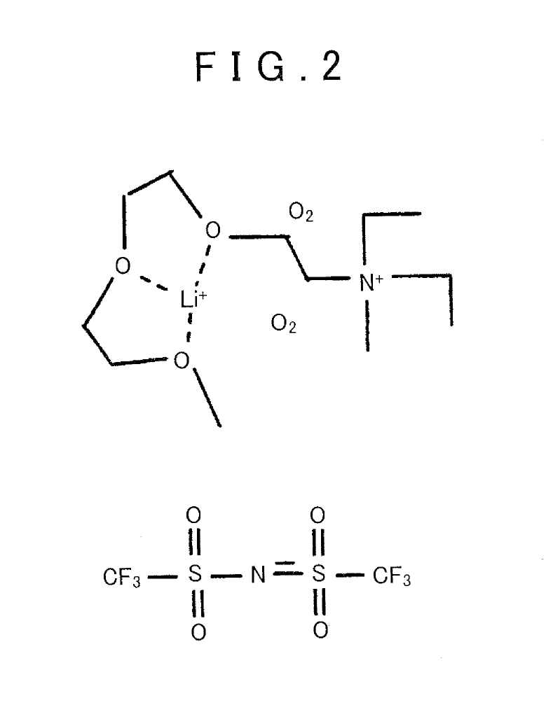

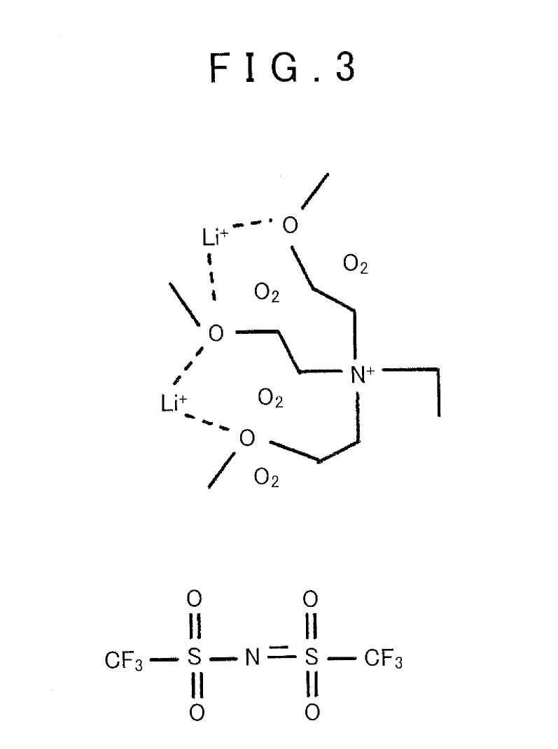

FIG. 1 is an example that uses
N,N-diethyl-N-methyl-N-(2-methoxyethyl)ammonium (DEME), which has one ether group and is represented by formula (5), as the cation moiety; here, the Li ion does not coordinate with the ether group in the cation moiety and an ordinary O₂ supply capacity is present. FIG. 2 is an example that uses DEME3, which is represented by formula (6) and has three ether groups incorporated in series, as the cation moiety; here, the Li ion coordinates with the serially incorporated ether groups and a fairly good O₂ supply capacity is present. FIG. 3 is an example that uses
N-methyl-N,N,N-tri(2-methoxyethyl)ammonium (N1(1o2)₃), which is represented by the preceding formula (3) and has three ether groups incorporated in parallel, as the cation moiety; here, more Li ion is coordinated with the ether groups incorporated in parallel and the O₂ supply capacity is very good.

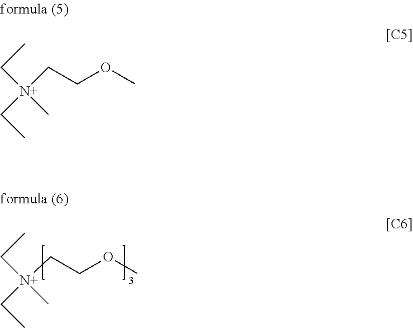

A lithium-air battery can be fabricated using an electrolyte solution that contains an ionic liquid that has a cation in which ether groups are incorporated in parallel. The lithium-air battery can have a positive electrode (air electrode) layer, a negative electrode layer, and an electrolyte layer disposed between the positive electrode layer and the negative electrode layer, and the electrolyte layer can contain an electrolyte solution that contains an ionic liquid that has a cation in which ether groups are incorporated in parallel.

The electrolyte solution that contains an ionic liquid that has a cation in which ether groups are incorporated in parallel can exchange a metal ion between the positive electrode layer and the negative electrode layer.

An ionic liquid that has a cation in which ether groups are incorporated in parallel may itself be used as the electrolyte, or an electrolyte may be used as provided by the addition to an ionic liquid that has a cation in which ether groups are incorporated in parallel—of another ionic liquid, e.g., N-methyl-N-propylpiperidinium bis(trifluoromethanesulfonyl)amide (PP13TFSA), DEMETFSA, DEME2TFSA, DEME3TFSA, and so forth, and/or an organic solvent, e.g., propylene carbonate, ethylene carbonate, diethyl carbonate, dimethyl carbonate, ethyl methyl carbonate, 1,2-dimethoxyethane, 1,2-diethoxyethane, acetonitrile, propionitrile, tetrahydrofuran, 2-methyltetrahydrofuran, dioxane, 1,3-dioxolane, nitromethane, N,N-dimethylformamide, dimethyl sulfoxide, sulfolane, γ-butyrolactone, the glymes, and so forth.

The ionic liquid that has a cation in which ether groups are incorporated in parallel may also be used mixed with an organic solvent as the electrolyte solution. By using as the electrolyte solution the combination of the ionic liquid with an organic solvent that has a viscosity lower than that of the ionic liquid, the viscosity of the electrolyte solution can be lowered while an excellent solubility for lithium oxide is exhibited. Proceeding in this manner, the low-viscosity electrolyte solution, while dissolving lithium oxide and ensuring a diffusion pathway for the lithium ion and oxygen molecule, can rapidly feed the Li ion and oxygen molecule to the electrode and can thereby improve the output characteristics of the lithium-air battery.

Organic solvents that can be used mixed with the ionic liquid that has a cation in which ether groups are incorporated in parallel can be exemplified by solvents that have a lower viscosity than the ionic liquid, are compatible with the ionic liquid, and do not contain an active proton. The organic solvent is preferably an ether group-containing organic solvent and is more preferably a glyme. The glyme can be exemplified by tetraglyme and triglyme, and the glyme is preferably used mixed with N12(1o2)₂TFSA, N1(1o2)₃TFSA, or their mixture.

The proportion (mol %) of the organic solvent with respect to the total amount of an electrolyte solution solvent containing an organic solvent and an ionic liquid that has a cation in which ether groups are incorporated in parallel is preferably not more than 98%, more preferably not more than 95%, even more preferably not more than 93.3%, yet more preferably not more than 68%, and still more preferably not more than 50%.

The ionic liquid that has a cation in which ether groups are incorporated in parallel may be used as the electrolyte in combination with a polymer electrolyte or a gel electrolyte.

The polymer electrolyte that may be used in combination with the ionic liquid that has a cation in which ether groups are incorporated in parallel is preferably a polymer electrolyte that contains a lithium salt and a polymer. The lithium salt should be a lithium salt as heretofore commonly used in, for example, lithium-air batteries, but is not otherwise particularly limited and can be exemplified by the lithium salts used as the previously described lithium-containing metal salts. The polymer should be able to form a complex with the lithium salt, but is not otherwise particularly limited and can be exemplified by polyethylene oxide and so forth.

The gel electrolyte that may be used in combination with the ionic liquid that has a cation in which ether groups are incorporated in parallel is preferably a gel electrolyte that contains a lithium salt, a polymer, and a nonaqueous solvent. The previously described lithium salts can be used as the lithium salt here. The nonaqueous solvent should be able to dissolve this lithium salt, but is not otherwise particularly limited and, for example, the previously described organic solvents can be used. Only a single such nonaqueous solvent may be used, or a mixture of two or more nonaqueous solvents may be used. The polymer should be capable of undergoing gelation, but is not otherwise particularly limited and can be exemplified by polyethylene oxide, polypropylene oxide, polyacrylonitrile, polyvinylidene fluoride (PVDF), polyurethane, polyacrylate, cellulose, and so forth.

An electroconductive material may be incorporated in the positive electrode (air electrode) layer in a lithium-air battery constructed using the electrolyte solution according to the invention. This electroconductive material is preferably a porous material, but there is no limitation to this. The porous material can be, for example, a carbonaceous material such as carbon, and this carbon can be exemplified by carbon blacks such as Ketjen black, acetylene black, channel black, furnace black, and mesoporous carbon, and by active carbon and carbon fibers, whereamong carbon materials that have a high specific surface area are preferred. In addition, the porous material desirably has a pore volume at the nanometer order of magnitude of approximately 1 mL/g The electroconductive material preferably accounts for 10 to 99 mass % of the positive electrode layer.

The positive electrode (air electrode) layer may contain a binder. For example, a fluororesin, e.g., polytetrafluoroethylene (PTFE), PVDF, or a fluororubber; a thermoplastic resin such as polypropylene, polyethylene, or polyacrylonitrile; or a styrene-butadiene rubber (SBR) may be used as the binder. The binder preferably accounts for 1 to 40 mass % of the positive electrode layer.

The positive electrode (air electrode) layer may contain an oxidation-reduction catalyst, and this oxidation-reduction catalyst can be exemplified by metal oxides, e.g., manganese dioxide, cobalt oxide, and cerium oxide; noble metals such as Pt, Pd, Au, and Ag; transition metals such as Co; and organic substances such as metal phthalocyanines, e.g., cobalt phthalocyanine, and Fe porphyrin. The oxidation-reduction catalyst preferably accounts for 1 to 90 mass % of the positive electrode layer.

A separator may be provided between the positive electrode layer and the negative electrode layer in a lithium-air battery constructed using the electrolyte solution according to the invention. There are no particular limitations on this separator, and, for example, a polymeric nonwoven fabric, e.g., a polypropylene nonwoven fabric or polyphenylene sulfide nonwoven fabric, or a microporous film of, e.g., an olefin resin such as polyethylene or polypropylene, or a combination of the preceding can be used as the separator. An electrolyte layer may be formed by impregnating an electrolyte, e.g., an electrolyte solution, into the separator.

The negative electrode layer present in a lithium-air battery constructed using the electrolyte solution according to the invention is a layer that contains a lithium-containing negative electrode active material. The heretofore used materials can be used as this lithium-containing negative electrode active material, and a lithium/carbon material, lithium metal, a lithium-containing alloy, or a lithium-containing metal oxide, metal nitride, or metal sulfide can be used. The lithium-containing alloy can be exemplified by lithium-aluminum alloys, lithium-tin alloys, lithium-lead alloys, and lithium-silicon alloys. The lithium-containing metal oxides can be exemplified by lithium titanium oxide. The lithium element-containing metal nitrides can be exemplified by lithium cobalt nitride, lithium iron nitride, and lithium manganese nitride. The lithium element-containing metal sulfides can be exemplified by lithium sulfide.

The negative electrode layer may additionally contain an electroconductive material and/or a binder. For example, the negative electrode layer may contain only the negative electrode active material when the negative electrode active material is a foil, while a negative electrode layer containing the negative electrode active material and a binder can be used when the negative electrode active material is a particulate. The same materials that can be used in the above-described positive electrode layer can be used here as the electroconductive material and binder.

The materials generally used as outer casing materials for air batteries, e.g., metal cans, resins, laminate packs, and so forth, can be used as the outer casing material used for a lithium-air battery constructed using the electrolyte solution according to the invention.

Pores for supplying oxygen can be disposed in freely selected locations in the outer casing material; for example, they can be disposed facing the side of the positive electrode layer in contact with the air. Dry air or pure oxygen is preferred for the oxygen source.

An oxygen-permeable membrane may be incorporated in a lithium-air battery constructed using the electrolyte solution according to the invention. This oxygen-permeable membrane can be disposed, for example, on the positive electrode layer on the side in contact with the air on the side opposite from the electrolyte layer. A water-repellent porous membrane permeable to the oxygen in the air and capable of stopping the entry of moisture can be used as this oxygen-permeable membrane. For example, a porous membrane of, for example, a polyester or polyphenylene sulfide can be used. A water-repellent membrane may also be provided separately.

A positive electrode current collector may be disposed adjacent to the positive electrode layer. The positive electrode current collector can generally be disposed on the positive electrode layer on the side in contact with the air on the side opposite from the electrolyte layer, but may be disposed between the positive electrode layer and the electrolyte layer. A material heretofore used as a current collector, e.g., carbon paper, a porous structure such as a metal mesh, a network structure, a fiber, a nonwoven fabric, and so forth, can be used without particular limitation as the positive electrode current collector, and, for example, a metal mesh formed from, e.g., stainless steel (SUS), nickel, aluminum, iron, titanium, and so forth, can be used. A metal foil provided with oxygen supply pores may also be used as the positive electrode current collector.

A negative electrode current collector can be disposed adjacent to the negative electrode layer. A material heretofore used as a current collector, e.g., an electroconductive material with a porous structure, a nonporous metal foil, and so forth, can be used without particular limitation as the negative electrode current collector, and, for example, a metal foil formed from, e.g., copper, SUS, or nickel can be used.

The shape of a lithium-air battery constructed using the electrolyte solution according to the invention should be a shape that has oxygen-inlet pores, but is not otherwise particularly limited, and a desired shape can be taken, for example, cylindrical, rectangular, button shaped, coin shaped, or flat.

A lithium-air battery constructed using the electrolyte according to the invention can be used as a secondary battery, but may also be used as a primary battery.

The positive electrode layer and the negative electrode layer present in a lithium-air battery constructed using the electrolyte solution according to the invention can be formed by any method heretofore carried out. For example, when the formation of a positive electrode layer containing carbon particles and a binder is sought, the positive electrode layer can be formed by adding an appropriate amount of a solvent such as ethanol to prescribed amounts of the carbon particles and binder; mixing; rolling out the obtained mixture to a prescribed thickness using a roll press; and drying and cutting. A positive electrode current collector can then be pressure-bonded followed by vacuum drying under the application of heat to obtain a positive electrode layer combined with a current collector.

In another method, a slurry is prepared by adding a suitable amount of a solvent to prescribed amounts of the carbon particles and binder with mixing and the positive electrode layer is then obtained by coating the slurry on a substrate and drying. The obtained positive electrode layer may be press molded as desired. For example, acetone, which has a boiling point of 200° C. or below, or N-methylpyrrolidone (NMP) can be used as the solvent for obtaining the slurry. The process for coating the positive electrode layer slurry on the substrate can be exemplified by doctor blade methods, gravure transfer methods, inkjet methods, and so forth. There are no particular limitations on the substrate used and, for example, the current collector sheet used as the current collector, a film-form flexible substrate, a rigid substrate, and so forth, can be used. For example, a substrate of an SUS foil, a polyethylene terephthalate (PET) film, or Teflon (registered trademark) can be used. The same methods may be used to form the negative electrode layer.

(Solvent Preparation)

The solvents used for the electrolyte solutions were prepared.
N-ethyl-N-methyl-N,N-di(2-methoxyethyl)ammonium bis(trifluoromethanesulfonyl)amide (N12(1o2)₂TFSA) was synthesized by changing the starting materials in the synthesis of the known substance N,N-diethyl-N-methyl-N-(2-methoxyethyl)ammonium bis(trifluoromethanesulfonyl)amide (DEMETFSA) as follows: the N,N-diethylmethylamine was changed to bis(2-methoxyethyl)amine and the 2-methoxyethyl bromide was changed to methyl bromide and ethyl bromide. N-methyl-N,N,N-tri(2-methoxyethyl)ammonium bis(trifluoromethanesulfonyl)amide (N1(1o2)₃TFSA) was synthesized by changing the starting materials in the synthesis of the known substance N,N-diethyl-N-methyl-N-(2-methoxyethyl)ammonium bis(trifluoromethanesulfonyl)amide (DEMETFSA) as follows: the N,N-diethylmethylamine was changed to bis(2-methoxyethyl)amine and the 2-methoxyethyl bromide was changed to 2-methoxyethyl bromide and methyl bromide. N,N-diethyl-N-methyl-N-(2-methoxyethyl)ammonium bis(trifluoromethanesulfonyl)amide (DEMETFSA) was acquired from Kanto Chemical Co., Inc. DEME2TFSA and DEME3TFSA were synthesized by changing the starting 1-bromo-2-methoxyethane in the synthesis of the known substance DEMETFSA to 1-bromo-2-(2-methoxyethoxy)ethane and diethylene glycol 2-bromoethyl methyl ether, respectively.

As indicated below, N12(1o2)₂TFSA and N1(1o2)₃TFSA, which have a plurality of ether groups incorporated in parallel, were used in respective examples;
DEMETFSA, which has one ether group, was used in a comparative example; and
DEME2TFSA and DEME3TFSA, which have a plurality of ether groups incorporated in series, were used in respective reference examples.

### EXAMPLE 1

Under a 60° C. Ar atmosphere, lithium bis(trifluoromethanesulfonyl)amide (LiTFSA, Kishida Chemical Co., Ltd.) was weighed out to provide a concentration of 0.32 mol/kg and was mixed with N12(1o2)₂TFSA as solvent; stirring for 6 hours produced the electrolyte solution.

### EXAMPLE 2

Under a 60° C. Ar atmosphere, lithium bis(trifluoromethanesulfonyl)amide (LiTFSA, Kishida Chemical Co., Ltd.) was weighed out to provide a concentration of 0.32 mol/kg and was mixed with N1(1o2)₃TFSA as solvent; stirring for 6 hours produced the electrolyte solution.

### COMPARATIVE EXAMPLE 1

Under a 60° C. Ar atmosphere, lithium bis(trifluoromethanesulfonyl)amide (LiTFSA, Kishida Chemical Co., Ltd.) was weighed out to provide a concentration of 0.32 mol/kg and was mixed with DEMETFSA as solvent; stirring for 6 hours produced the electrolyte solution.

### REFERENCE EXAMPLE 1

Under a 60° C. Ar atmosphere, lithium bis(trifluoromethanesulfonyl)amide (LiTFSA, Kishida Chemical Co., Ltd.) was weighed out to provide a concentration of 0.32 mol/kg and was mixed with DEME2TFSA as solvent; stirring for 6 hours produced the electrolyte solution.

### REFERENCE EXAMPLE 2

Under a 60° C. Ar atmosphere, lithium bis(trifluoromethanesulfonyl)amide (LiTFSA, Kishida Chemical Co., Ltd.) was weighed out to provide a concentration of 0.32 mol/kg and was mixed with DEME3TFSA as solvent; stirring for 6 hours produced the electrolyte solution.

(Evaluation of the LiOx Production Capacity)

The LiOx production capacity was evaluated by carrying out electrochemical measurements according to the following conditions on the electrolyte solutions prepared in Examples 1 and 2, Comparative Example 1, and Reference Examples 1 and 2.

An airtight three-electrode measurement cell was used that had glassy carbon (diameter=3 mm) for the working electrode, Ag/Ag⁺ for the reference electrode, and Ni for the counterelectrode. A potentiostat/galvanostat (Solartron) was used for the measurement instrumentation. For each electrolyte solution, the atmosphere within the electrolyte solution-filled measurement cell was replaced with an argon atmosphere; replacement with an oxygen atmosphere was then performed by bubbling the electrolyte solution with pure oxygen for 30 minutes; and holding at quiescence was thereafter carried out for 3 hours in a thermostat at 1 atmosphere and 60° C. This was followed by an LSV measurement in the range from −0.3 to −1.3 V vs. Ag/Ag⁺ at 60° C. and 1 atmosphere in an oxygen atmosphere.

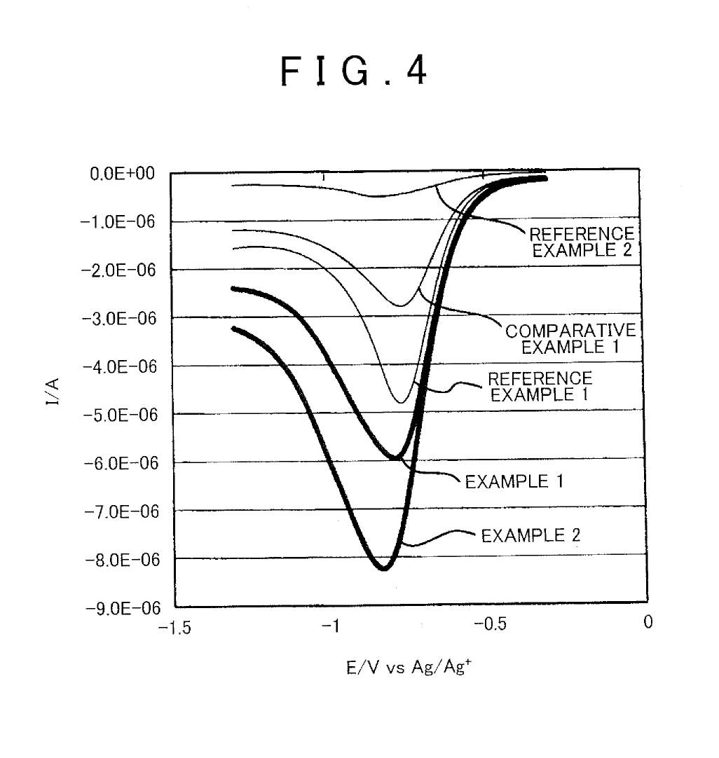

The LSV curves measured for the individual electrolyte solutions are shown in FIG. 4. Each of the electrolyte solutions prepared in Examples 1 and 2 had an LiOx production peak current value as observed at approximately −0.8 V that was approximately three-times larger than for the electrolyte solution prepared in Comparative Example 1 and approximately 71% larger than for the electrolyte solution prepared in Reference Example 1, and thus exhibited a high LiOx production capacity.

1. An electrolyte solution for a lithium-air battery, containing an ionic liquid that has a cation in which ether groups are incorporated in parallel.

2. The electrolyte solution according to claim 1, wherein the ionic liquid contains a quaternary ammonium cation as represented by the following formula 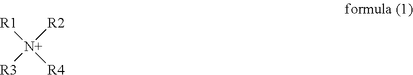
in the formula, at least two groups among R1, R2, R3, and R4 each contain from 1 to 7 carbon atoms, a hydrogen atom, and from 1 to 3 oxygen atoms; the remaining groups each contain from 1 to 8 carbon atoms, a hydrogen atom, and from 0 to 3 oxygen atoms; and the number of oxygens present in R1, R2, R3, and R4 is a maximum of 12.

3. The electrolyte solution according to claim 2, wherein the at least two groups containing the oxygen atoms among the R1, R2, R3, and R4 have the same structure.

4. The electrolyte solution according to claim 1, wherein the ionic liquid contains an ammonium cation (N12(1o2)2) represented by formula (2) 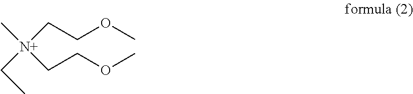
or an ammonium cation (N1(1o2)3) represented by formula (3) 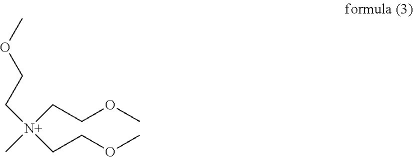
or their mixture.

5. The electrolyte solution according to claim 1, further comprising: an organic solvent.

6. The electrolyte solution according to claim 1, further comprising: bis(trifluoromethanesulfonyl)amide (TFSA) represented by the following formula

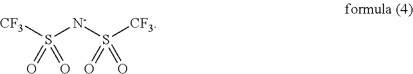 [SMILES: O=S(=O)([N-]S(=O)(=O)C(F)(F)F)C(F)(F)F]

7. The electrolyte solution according to claim 1, further comprising: a lithium-containing metal salt.

8. The electrolyte solution according to claim 7, wherein the lithium-containing metal salt is lithium bis(trifluoromethanesulfonyl)amide (LiTFSA).

9. A lithium-air battery comprising:
a positive electrode layer;
a negative electrode layer; and
an electrolyte layer that contains the electrolyte solution according to claim 1 and that is disposed between the positive electrode layer and the negative electrode layer.
